(19) United States
(12) Patent Application Publication
(10) Pub. No.: US 2023/0059716 A1
(43) Pub. Date: Feb. 23, 2023

(54) MOTOR UNIT AND MOTOR-CONTROL DEVICE

(71) Applicant: CHIPMAST AUTOTRONIX CO., LTD., Hsinchu County (TW)

(72) Inventors: HUNG-TA KUO, Hsinchu County (TW); CHI-JU LEE, Hsinchu County (TW)

(21) Appl. No.: 17/405,803

(22) Filed: Aug. 18, 2021

(51) Int. Cl. F04C 13/00; B60T 17/02; F16C 35/06

(52) U.S. Cl. CPC F04C 13/001; B60T 17/02; F16C 35/06; F04C 2210/206; F04C 2240/40; F04C 2240/50; F04C 2240/60; F04C 2240/30

(57) ABSTRACT

The present disclosure provides a motor unit and a motor-control device using the same, wherein the motor includes a motor element, a housing and a bearing. The motor element is contained within the housing, the bearing is fastened on a lower-edge portion of the housing and protrudes therefrom. The motor-control device includes a main body, and the motor unit mounted on the main body.

### TECHNICAL FIELD

The present disclosure relates to a motor unit and a motor-control device using the same, wherein the motor unit has a bearing exposed out of a motor housing.

### BACKGROUND

For safe driving, many modern vehicles are disposed with anti-lock braking systems (ABS), which are adapted to adjust braking function of wheels, such that to adjust traction force and prevent the wheels from locking up then slipping out of control, during emergency braking or driving on a road with inappropriate condition.

Common ABS systems can adjust the traction force by utilizing combination of software (programming), hardware (controller) and transmission mechanisms, such that to help gaining controllability of the vehicle against any accident. The modern ABS systems mainly employ hydraulic equipment as the transmission mechanism, which is assembled from multiple components connected to each other by welding, such that to achieve high fluid tightness.

The welding process can easily bind, connect surfaces in different or complicated shapes together, however the connection by welding is vulnerable to vibration and high temperature. A hydraulic equipment with motors and pumps that generates vibrations and heat, which may lose its fluid-tight condition after some usage, especially when the emergency brake is applied, the hydraulic equipment works at an instantly fast rate, which also generates enormous vibrations and heat in short burst and may destruct and break up the connection between welded components, and thereby to cause failure of the ABS system.

The motor as a main power source of the hydraulic equipment, which especially bears great amount of loadings during operations, such as stresses and vibrations, therefore the motor is required to be disposed stably. A conventional motor disposed on a bottom seat of the hydraulic equipment, which has a housing with rough dimensions and middle-class rigidness, and which is hence usually first disposed in a loose-running manner to keep some gap space between the motor and the bottom seat, then next to fill up the gap space or directly process a welding to fasten and seal the motor on the bottom seat. However, precisions and qualities of the gap-space-filling and the welding process may be unstable, therefore the motor may be positioned inappropriately and hence easily to have the components overloaded and broken during the operation, due to an unstable, jerking torque transmission.

### SUMMARY

Therefore, to overcome the abovementioned drawbacks of the conventional technology, the present disclosure provides a motor unit which has the bearing disposed on, protruding out and hence partially exposed out of a lower-edge portion of the housing. By virtue of such improved structural relationships and positions of the components, an assembling process of the components is also simplified, such that the motor unit can be easily fastened and sealed within a main body of the motor-control device by riveting. Thereby, no need of the welding and fulling-up process for fastening and sealing the motor unit of the motor-control device, and therefore to prevent the motor unit from being inappropriately positioned.

According to at least one of the abovementioned object, the present disclosure provides a motor-control device which includes a main body and a motor unit. The main body has a mounting slot for containing the motor unit therein, the motor unit has an exposed bearing that has an appearance corresponding to that of the mounting slot. Such that, the motor unit can be mounted therein in manner of engineering fit, thereby to tightly contact and be precisely joined to an inner wall of the mounting slot when as the bearing is exposed, and therefore to improve a connection between the motor unit and the main body of the motor-control device, so as a structural stability of the motor unit and the motor-control device against loading.

According to at least one of the abovementioned object, the present disclosure provides a motor unit, which includes a housing, a motor element disposed within the housing, and a bearing disposed on a lower-edge portion of the housing, wherein the bearing partially protrudes from the lower-edge portion of the housing.

Optionally, the motor unit may further include a spinner disposed beneath the bearing, wherein the spinner is connected to a rotary shaft of the motor element.

Optionally, the bearing is a ball bearing, and the rotor is a cam.

Optionally, the bearing has an upper portion and a lower portion, wherein the upper portion is disposed within the housing, and the lower portion is exposed out of the housing.

Optionally, the upper portion of the bearing is connected to the lower-edge portion of the housing, and the lower portion of the bearing protrudes from the lower-edge portion.

Optionally, the upper portion of the bearing has a height equal to that of the lower-edge portion of the housing.

Optionally, the bearing has an outer diameter equal to or less than an inner diameter of the lower-edge portion of the housing.

According to at least one of the abovementioned object, the present disclosure provides a motor-control device, which includes a main body and the abovementioned motor unit, wherein the motor unit is disposed within the mounting slot of the main body. The bearing of the motor unit protruding out from the lower-edge portion of the housing, which has an outer wall that contacts and fits the inner wall of the mounting slot of the main body.

Optionally, the motor-control device further includes an actuator disposed within the main body and power-transmittably connected to the motor unit.

Optionally, the motor-control device is an anti-lock braking system (ABS), and the actuator is an oil scavenge pump.

To be brief, the motor unit and the motor-control device according to the present disclosure, which improves a structural positions and relationships between the motor unit and other components, such as to have the bearing protruding out of the housing and as so to simplify an assembling relationship therebetween, and to facilitate a process of mounting the motor with no need of welding. Such that, by virtue of the disposing and fastening manner which the bearing of the motor unit directly contacts and fits the inner wall of the main body, the motor unit can operate smoothly in a proper position with stable structural strength. Therefore, the motor unit has an effective advantage to adapt to the motor-control device (e.g. the ABS device), and furthermore to adapt to market demands (e.g. car, motorcycle or ABS manufacturers, etc.).

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is a schematic external view of a motor unit, according to one embodiment of the present disclosure.

FIG. 2 is a schematic sectional view of a motor unit, according to one embodiment of the present disclosure.

FIG. 3 is a schematic perspective view illustrating an assembling relationships between the motor unit and a main body of a motor-control device, according to one embodiment of the present disclosure.

FIG. 4 is a schematic sectional view of the motor-control device, according to one embodiment of the present disclosure.

FIG. 5 is a schematic sectional view of the motor-control device, according to another embodiment of the present disclosure.

FIG. 6 is a perspective view of the motor-control device, according to one embodiment of the present disclosure.

FIG. 7 is a perspective view illustrating an interior of the motor-control device, according to one embodiment of the present disclosure.

FIG. 8 is a perspective exploded view of the motor-control device, according to one embodiment of the present disclosure.

FIG. 9 is a sectional view of the motor-control device, according to one embodiment of the present disclosure.

### DETAILED DESCRIPTION OF THE PREFERRED EMBODIMENTS

To fully understand the objects, features and functions of the present disclosure, herein to explain details thereof by the following embodiment(s), with the attached drawings.

The present disclosure provides a motor unit, which includes a motor element, a housing containing the motor element, and a bearing mounted on a lower-edge portion of the housing. The bearing has an upper portion disposed within the lower-edge portion of the housing, and a lower portion protruding and exposed out of the lower-edge portion. The present disclosure also provides a motor-control device, which includes the motor unit and a main body. The main body has a plurality of mounting slots spatially connected to each other, and for mounting the motor unit and an actuator. The lower portion of the bearing has an outer wall contacting and fitting an inner wall of a corresponding one of the mounting slots on the main body. The actuator is power-transmittably connected to the motor unit, via another one of the mounting slots. By virtue of the motor unit which has the housing and the bearing mounted into the mounting slot on the main body of the motor-control device in a manner of engineering fit, a connection between the motor unit and the main body is more stable, moreover an assembling process thereof can be also simplified.

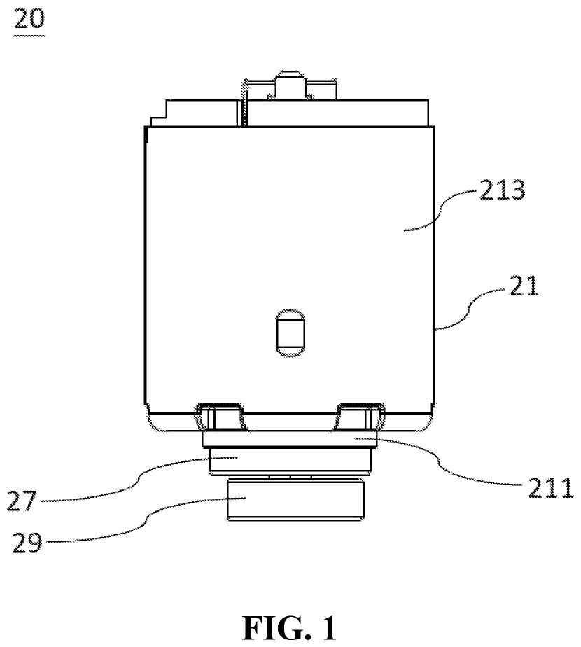

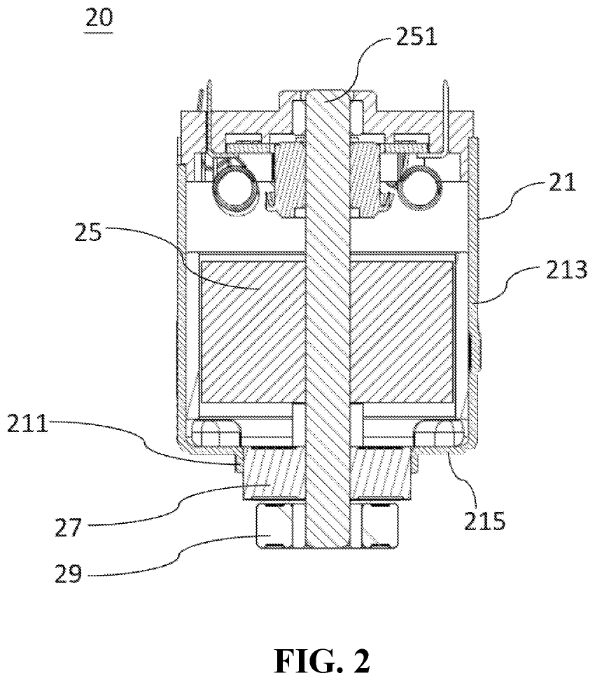

First referring to FIG. 1 and FIG. 2, which are respectively a schematic external view and a schematic sectional view of a motor unit, according to one embodiment of the present disclosure. As shown in the FIGs, the motor unit 20 according to the present disclosure has a proximately cylindrical appearance, and includes a housing 21, a motor element 25, a bearing 27 and a spinner 29. The motor element 25 is disposed within the housing 21, and the bearing 27 and the spinner 29 are disposed beneath the housing 21. The motor element 25 includes a rotary shaft 251, a motor circuit (not shown), a stator and a rotor (not shown), wherein type of the motor element 25 as shown does not limit claim scope of the present disclosure. The rotary shaft 251 of the motor element 25 sequentially extends through the housing 21, the bearing 27 and connects to the spinner 29, for driving the spinner 29 to rotate, spin. The bearing 27 is disposed between the housing 21 and the spinner 29, and positioned below the housing 21. Also, the bearing 27 partially protrudes and be exposed out of the housing 21.

The housing 21 is a hollow tubular body that has an upper end and a lower end respectively formed with openings, and the motor element 25 is contained within the housing 21. Specifically, the housing 21 may include a main portion 213, a bottom portion 215 and a lower-edge portion 211, wherein the main portion 213 is connected to an end of the bottom portion 215, the lower-edge portion 211 is connected to another end of the bottom portion 215. The main portion 213 is disposed perpendicular to the bottom portion 215, and thereby to form an angle of substantially 90 degrees therebetween. The lower-edge portion 211 is also disposed perpendicular to the bottom portion 215, with an angle of substantially 90 degrees therebetween. The lower-edge portion 211 and the main portion 213 are disposed substantially parallel to each other, and at two opposite sides of the bottom portion 215. Such that, the housing 21 has the openings respectively formed on the main portion 213 and the lower-edge portion 211, as the upper opening and the lower opening. Such that, the motor element 25 may be mounted into the main portion 213 via the upper opening, and the bearing 27 may be mounted into the lower-edge portion 211 via the lower opening.

In this embodiment, the housing 21 surrounds an axis, with the main portion 213 extends downward along the axis, then be bent inward to form the bottom portion 215 for shrinkage, and then again bent and extend downward along the axis to form the lower-edge portion 211. As shown in the FIGs, the main portion 213 has a diameter greater than that of the lower-edge portion 211, thereby the housing 21 has the upper opening larger than the lower opening. However, the present disclosure is not limited by such appearance of the housing 21, in another embodiment, the housing may alternatively have the main portion formed with a diameter less than that of the lower-edge portion, and hence the bottom portion is bent outward from the main portion to connect the lower-edge portion. Moreover, the housing 21 may be formed as one single component in this embodiment, but may also be formed as an assembly of the multiple components in another embodiment, the present disclosure is not limited thereto.

The bearing 27 is a hollow annular body, which has an outer diameter equal to or less than an inner diameter of the lower-edge portion 211 of the housing 21. Such that, the bearing 27 can be connected to the housing 21 by fitting into the lower opening on the lower-edge portion 211. Also, the bearing 27 is fastened into and protrudes out from the lower-edge portion 211 of the housing 21. In this embodiment, the bearing 27 is disposed on the housing 21 in a coaxial and concentric manner, and protrudes downward from the lower-edge portion 211 of the housing 21. The bearing 27 is mounted on the housing 21 for sustaining the rotary shaft 251 against machine loadings, thereby the motor element 25 (e.g. rotor, but not limited thereto) can rotate smoothly and stably.

To be specific, the bearing 27 has an upper portion and a lower portion, the upper portion is within the housing 21 and engaged with the lower opening on the lower-edge portion 211, and the lower portion protrudes and be exposed out of the lower-edge portion 211 of the housing 21. The upper portion of the bearing 27 has a height proximate to or equal to that of the lower-edge portion 211 of the housing 21. Also, the upper portion of the bearing 27 has an outer surface contacting and fitting the inner wall of the lower-edge portion 211 of the housing 21, along with that, the upper portion of the bearing 27 is positioned within the lower-edge portion 211 of the housing 21. Moreover, as shown in FIGs, the bearing 27 is preferable to insert into the housing 21 from the lower-edge portion 211 to the bottom portion 215, just before the main portion 213. However, the present disclosure is not limited thereto, the bearing 27 may insert into the main portion 213 in another embodiment. In this embodiment, the bearing 27 is engaged with the housing 21 in a manner of engineering fit, such as interference fit or transition fit, however the present disclosure is not limited thereto. The bearing 27 is preferable as a rolling-element type bearing, such as a ball bearing or roller bearing, however the present disclosure is not limited thereto, the bearing 27 may also be a slide bearing, universal joint bearing or oil bearing, etc.

The spinner 29 is positioned beneath the bearing 27 and connected to the rotary shaft 251 of the motor element 25. When the motor unit 20 operates, the rotary shaft 251 is driven to turn and spin the spinner 29, also to note that the housing 21, the bearing 27 and the spinner 29 of the motor unit 20 are all coaxial, concentric. In one embodiment, the bearing 27 is a ball bearing, and the spinner 29 is a cam, however the present disclosure is not limited to such types of the bearing 27 and the spinner 29.

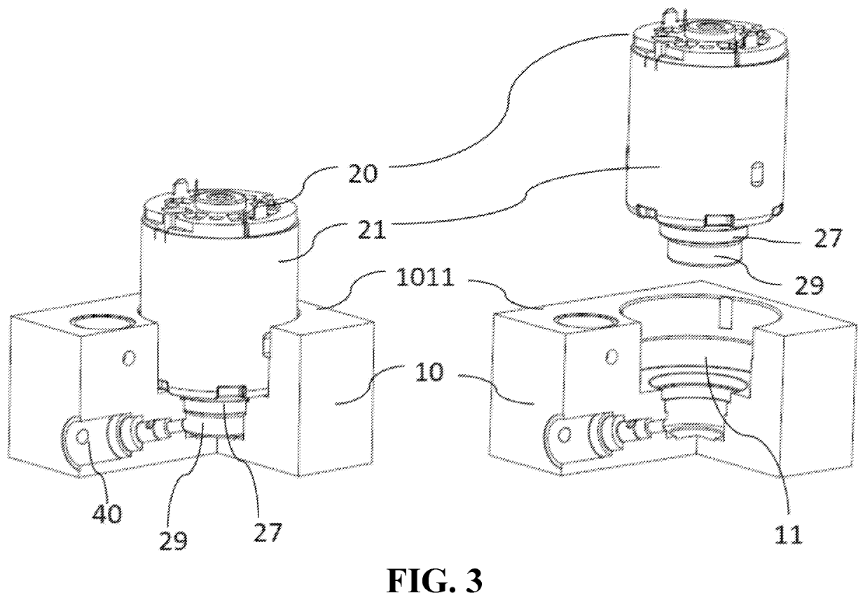

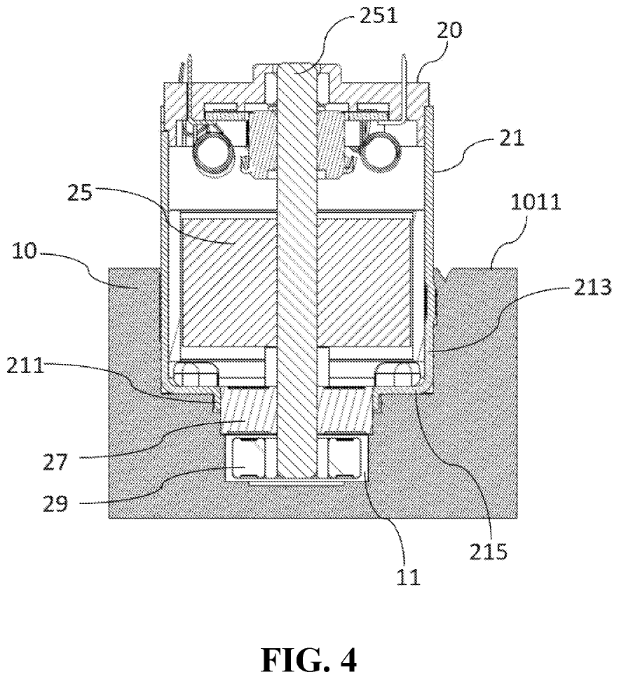

Next to refer to FIG. 3 and FIG. 4, which are respectively a schematic perspective view illustrating an assembling relation of the motor unit and a main body of a motor-control device, and a schematic sectional view of the motor-control device, according to one embodiment of the present disclosure. The main body 10 of the motor-control device 1 has the mounting slot 11, wherein the mounting slot 11 is a cavity extending downward from a top surface 1011 of the main body 10. The inner wall of the mounting slot 11 has a shape corresponding to that of the motor unit 20, for containing the motor unit 20. As shown in the FIGs, the appearance of the motor unit 20 is a combination of that of the housing 21, the bearing 27 and the spinner 29, wherein the three component 21, 27, 29 are all coaxial, concentric and have different peripheries or outer diameters from large to small sequentially, along with that, the inner wall of the mounting slot 11 is also formed with round stepped surfaces corresponding thereto, and the stepped surfaces are disposed downward from the upper surface 1011 of the main body 10 and have different inner diameters from larger to small also.

When mounting the motor unit 20 into the mounting slot 11 of the main body 10, the motor unit 20 is disposed into the main body 10 by having the bearing 27 and the spinner 29 facing the mounting slot 11, in a simple mounting manner. The motor unit 20 mounted into the main body 10, which has the housing 21 and the bearing 27 partially contacting and fitting the inner wall of the mounting slot 11, except for the spinner 29 that requires space to spin and rotate therefore does not contact the inner wall of the mounting slot 11. The main portion 213, the bottom portion 215 and the lower-edge portion 211 of the housing 21 all contacts and fits the inner wall of the mounting slot 11. In this embodiment, the mounting slot 11 of the main body 10 is formed with a depth only to partially contain the motor unit 20 (the lower portion the motor unit 20), thereby the main portion 213 of the housing 21 contacts and fits the inner wall of the mounting slot 11 partially. However surely, the present disclosure is not limited thereto, the mounting slot 11 of the main body 10 also may be configured to fully contain the motor unit 20.

The lower portion of the bearing 27 has an outer wall that contacts and fits the inner wall of the mounting slot 11, and more preferably in a tight contacting manner. Different from the housing 21, the bearing 27 is sensitive component that requires precise dimensions and high rigidness, for sustaining and allowing the rotary shaft 251 to smoothly rotate and spin, and also for bearing other rotatable components (e.g. the spinner 29 but not limited thereto) mounted on the rotary shaft 251. Therefore, the bearing 27 can be disposed into the mounting slot 11 in manner of transition fit, to tightly contact and fit the inner wall of the mounting slot 11, such that the motor unit 20 is fastened and stabilized, to prevent misalignment and improve concentricity of those component 25, 27 29. Also, by virtue of the bearing 27 that has the outer wall of the upper portion tightly contacting and fitting the inner wall of the lower-edge portion 211 of the housing 21, and that has the outer wall of the lower portion tightly contacting and fitting the inner wall of the mounting slot 11 of the main body 10, loadings on the motor unit 20 during an operation thereof can be stably shared by the main bodyl0, such that to prevent the motor unit 20 from vibrating or overloading then damaging the components 25, 27, 29 and other related structures. However, the present disclosure is not limited to connect, engage the bearing 27 with the mounting slot 11 in such manner, it may be configured to interference fit or shrink fitting in other embodiments.

In one embodiment, the motor unit 20 may be mounted into the mounting slot 11 of the main body 10 by press fit, and surely, the present disclosure is not limited thereto.

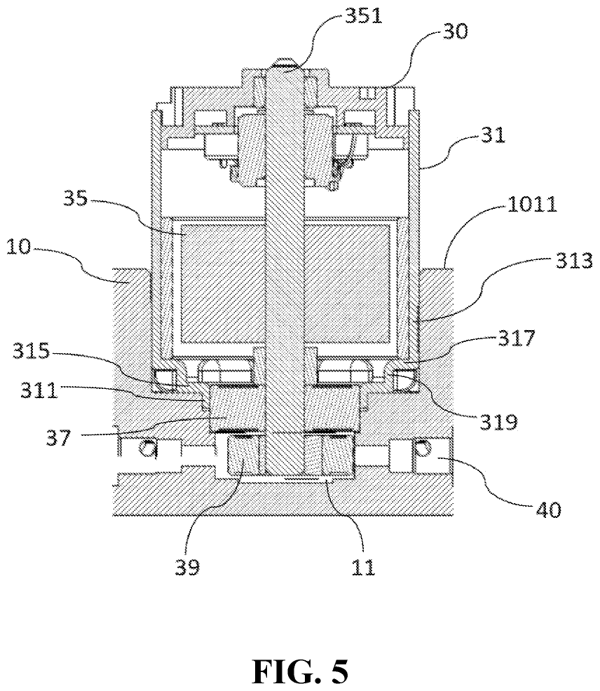

Referring to FIG. 5, which is a schematic sectional view of the motor-control device, according to another embodiment of the present disclosure. The motor unit 30 has a structure similar to the motor unit 20, and includes a housing 31, a motor element 35 disposed within the housing 31, a bearing 37 disposed beneath and protruding out of the housing 31, and a spinner 39 disposed beneath the bearing 37. Also, the motor element 35 has a rotary shaft 351 extending through the housing 31, the bearing 37 and connect to the spinner 39. A difference between the motor unit 30 and the motor unit 20 is in a structure of the housing 31, to be specific, the housing 31 has a main portion 313, and a bottom portion 315 and a lower-edge portion 311 connected to each other, wherein the main portion 313 and the bottom portion 315 have an inter-bottom portion 317 and an inter-lower-edge portion 319 disposed therebetween. The inter-bottom portion 317 has an end connected to the main portion 313, and another end connected to an end of the inter-lower-edge portion 319, and moreover the inter-bottom portion 319 has another end connected to the bottom portion 315. In this embodiment, the main portion 313 and the bottom portion 315 are not directly connected to each other but yet perpendicular to each other, also the main portion 313 is disposed parallel to the lower-edge portion 311.

As shown in the FIG, when the motor unit 30 is mounted into the mounting slot 11 of the main body 10, the housing 31 and the bearing 37 of the motor unit 30 partially contact and fit the inner wall of the mounting slot 11, similar to aforementioned embodiment. The housing 31 is positioned within the main body 10 and has the main portion 313, the bottom portion 315 and the lower-edge portion 311 all contact and fit the inner wall of the mounting slot 11, also the lower portion of the bearing 37 has an outer surface contacting tightly and fitting to the inner wall of the mounting slot 11, such that to stabilize the motor unit 30 and enhance its structural strength by the main body 10, similar to aforementioned embodiment.

In other embodiments, the housing 21 may be configured as to have the main portion 213 further extending downward to cover and contain the bottom portion 215 and the lower-edge portion 211 therein, but still have the bearing protruding out from the lower-edge portion 211 and out of the entire housing 21. Otherwise, the housing 21 may be configured to have a lower part of the main portion 213 to serve as the lower-edge portion 211 and hence without the shrinking bottom portion 215, such that the bearing 27 is formed with an outer diameter substantially equal to the inner diameter of the main portion 213, for mounting into the main portion 213. As abovementioned, the appearance the housing does not limit the claim scope of the present disclosure, it is only sufficient for the bearing to protrude from and be exposed out of the housing, and further to tightly contact and fit the inner surface of the mounting slot, when the motor unit is mounted into the main body of the motor-control device.

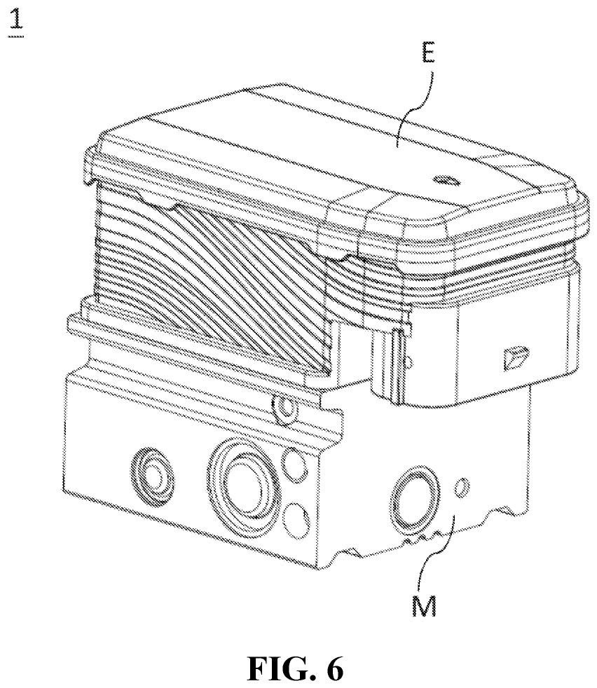

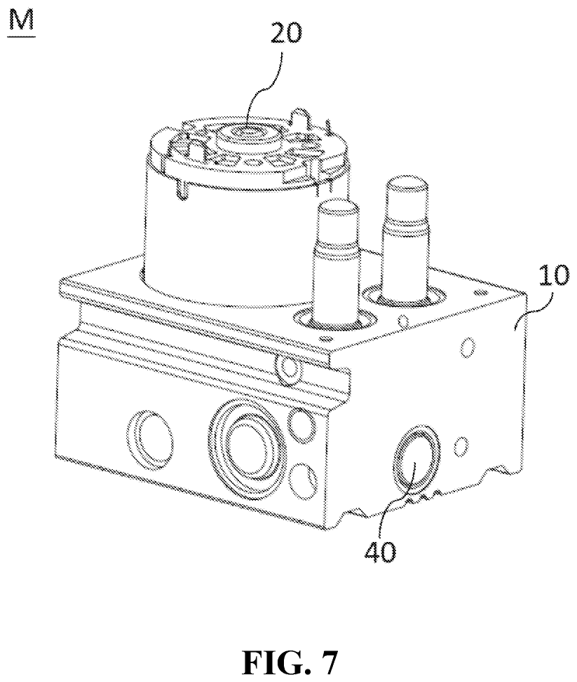

Referring to FIG. 6, which is a perspective view of the motor-control device, according to one embodiment of the present disclosure. As shown in the FIG, the motor-control device 1 according to the present disclosure (e.g. anti-lock braking system, ABS, but not limited thereto), which is generally assembled from an electronic component (E) and a mechanical component (M), and which has a long, proximately rectangular appearance. The electronic component (E) has a length slightly longer than that of the mechanical component (M), such that the motor-control device 1 has a lower portion and an upper portion protruding more than the lower portion at one side (or has a notch space at one side of the lower portion). Furthermore, FIG. 7 is a perspective view illustrating an interior of the motor-control device, according to one embodiment of the present disclosure. As shown in the FIG, the mechanical component (M) includes a main body 10, a motor unit 20 and an actuator 40 (e.g. oil scavenge pump but not limited thereto).

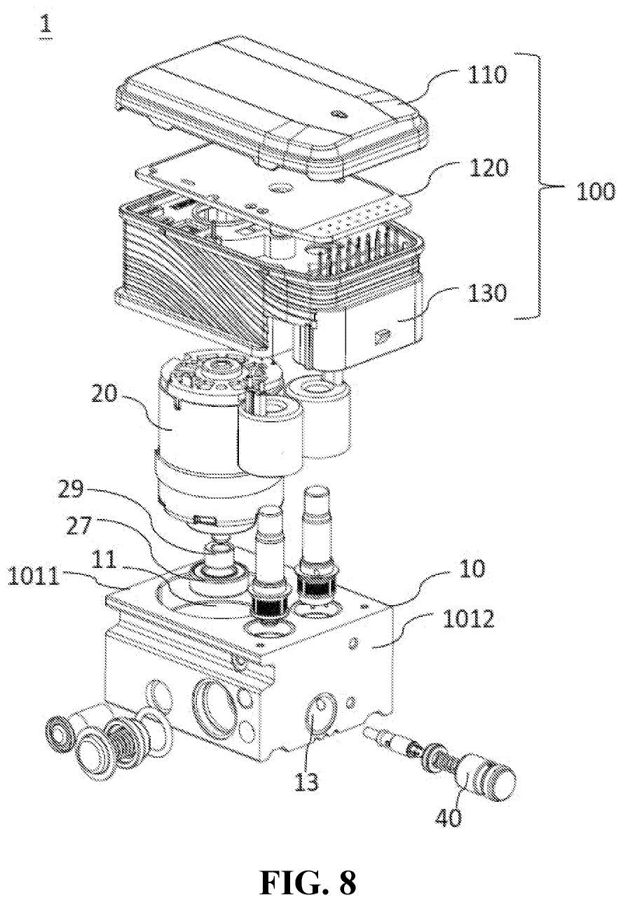

Next referring to FIG. 8, is a perspective exploded view of the motor-control device, according to one embodiment of the present disclosure. As shown in the FIG, the electronic component (E) of the motor-control device 1 may be an electronic control unit (ECU) 100, wherein the ECU 100 is electrically connected to the motor unit 20 for controlling the operation of the motor unit 20. In one embodiment, the ECU 100 is a microcontroller unit, the motor unit 20 is a servo motor, however surely the present disclosure is limited to such types of the ECU 100 and motor unit 20 and such connection manner between, as long as the ECU 100 is able to control the motor unit 20. The ECU 100 includes a top cover 110, a control board 120 and a frame body 130, wherein the top cover 110, control board 120 and the frame body 130 are stacked together to form a long, proximately rectangular appearance. The frame body 130 can be mounted on the main body 10, to contain the upper portion of the motor unit 20 which protrudes from the main body 10 therein.

As shown in FIG. 8, the main body 10 has a long, proximately rectangular appearance, and is formed with a plurality of mounting slots 11, 13 spatially connected to each other, wherein the mounting slot 11 is disposed on a top surface 1011 of the main body 10 for mounting the motor unit 20 therein. The main body 10 also has a first side surface 1012 disposed with the another mounting slot 13 for mounting the actuator 40 therein. The motor unit 20 is mounted into the mounting slot 11 of the main body 10 by having the axis of the housing 21 substantially perpendicular to the top surface 1011. The actuator 40 is mounted into the another mounting slot 13 in a manner that an axis of the actuator 40 is substantially parallel to the top surface 1011 and perpendicular to the first side surface 1012. Such that, the axis of the motor unit 20 is substantially perpendicular to that of the actuator 40, this can fully utilize inner spaces within the main body 10 for all of the component 20, 40 to operate and function, thereby the entire motor-control device 1 can have a small, compact size and volume.

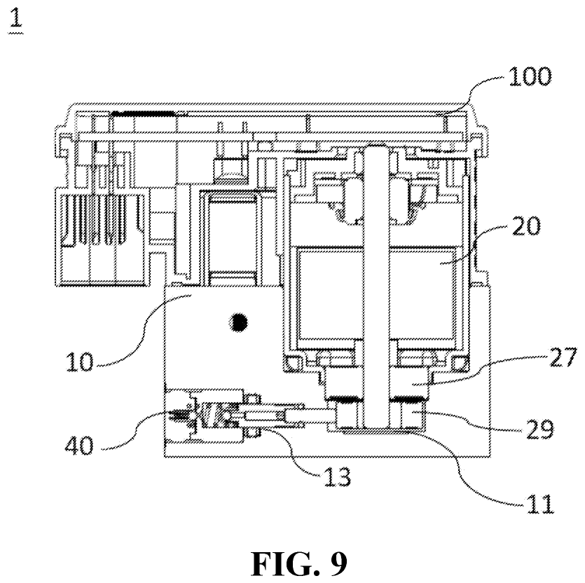

Also referring to FIG. 9, which is a sectional view of the motor-control device, according to one embodiment of the present disclosure. As shown in the FIG, the main body 10 has the mounting slot 11 and the another mounting slot 13 spatially connected to each other, wherein the motor unit 20 is disposed within the mounting slot 11, and the actuator 40 is disposed within another mounting slot 13 to power-transmittably connect to the motor unit 20. To be specific, the spinner 29 of the motor unit 20 within the mounting slot 11 is connected to the actuator 40 within the another mounting slot 13, and the motor unit 20 drives the actuator 40 via the spinner 29. Moreover, by virtue of disposing the bearing 27, loadings on the spinner 29 can be shared thereby when the motor-control device 1 activates the motor unit 20 to operate. Moreover, as the motor unit 20 generates heat during the operation, the main body 10 can help to conduct and dissipate the heat by the tight connection therebetween.

Here to explain an assembling process of the motor-control device 1 according to the present disclosure. At first, the motor unit 20 is brought to examine, to check if the bearing 27 and the spinner 29 are well attached and assembled with the motor element 25 and the housing 21, and ready for mounting into the mounting slot 11 of the main body 10. At this point, the motor element 25 may be already disposed within the housing 21 as a preset component in advance, whereas the bearing 27 and the spinner 29 are separate components, it is preferable to first assemble all of the components 21, 25, 27, 29 into the motor unit 20, then mount the motor unit 20 into the mounting slot 11 of the main body 10, since the bearing 27 and the spinner 29 have power-transmitting structural relationship with the motor element 25 and the housing 21. However, the present disclosure is not limited thereto, in another embodiment, the bearing 27 and the spinner 29 may be mounted into the mounting slot 11 of the main body 10 in advance and in a coaxial, concentric and stack-up manner, with the bearing 27 above the spinner, and later on to be assembled with the motor element 25 and the housing 21, within the mounting slot 11.

On next, the motor unit 20 may be mounted into the mounting slot 11 on the top surface 1011 of the main body 10 by press fit but not limited thereto. Due to a contour of the mounting slot 11 is similar and corresponding to that of the motor unit 20, thereby the housing 21 of the motor unit 20 can fit and be tightly fastened within the mounting slot 11, with the protruding lower portion of the bearing 27 tightly contacting and fitting the inner wall of the mounting slot 11. For more, the motor unit 20 may be further fastened within the mounting slot 11 of the main body 10 by riveting.

Thereafter, the actuator 40 is mounted into the another mounting slot 13 on the first side surface 1012 of the main body 10, wherein the two mounting slots 11, 13 are spatially connected to each other, thereby the actuator 40 can be power-transmittably connected to the motor unit 20, and directly driven by the motor unit 20. However not limited thereto, the motor unit 20 may also have the bearing 27 and the spinner 29 to drive the actuator 40 in an indirect manner, in another embodiment.

At last, the ECU 100 is mounted on the top surface 1011 of the main body 10, to cover and contain the upper portion the motor unit 20 that protrudes from the top surface 1011 of the main body 10, such that the assembling process of the motor-control device 1 is complete.

In summary of the abovementioned embodiments, in contrary to the conventional technology, the present disclosure can offer the following technical advantages.

For the conventional technology, the motor-control device has many components fastened, sealed by welding and filling up process, however with unstable quality of welding may directly affect a tightness of the sealed components, also, the connection between the welded components are vulnerable to vibration and high temperature, those may cause safety problems and misalignment of the components. In other hand, the motor unit and the motor-control device according to the present disclosure, which assembles the components simply by engineering fit, and additionally with riveting to further fasten, stabilize the components from breaking apart due to rapid vibration or high temperature generated from the operation, thus no need of welding. Moreover, the motor unit according to the present disclosure has the out-protruding bearing that serves both functions of sustaining and fastening, therefore can simplify the process of assembling motor unit into the main body by engineering fit and also improve an efficiency thereof

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

We claim:

1. A motor unit, comprising:
a housing;
a motor element disposed within the housing; and
a bearing fastened on a lower-edge portion of the housing and partially protruding out from the lower-edge portion.

2. The motor unit according to claim 1, further comprising a spinner disposed beneath the bearing, wherein the motor element includes a rotary shaft extending through the bearing and connected to the spinner.

3. The motor unit according to claim 2, wherein the bearing is a ball nearing, and the spinner is a cam.

4. The motor unit according to claim 1, wherein the bearing has an upper portion and a lower portion, the upper portion is positioned within the housing, and the lower portion is exposed out of the housing.

5. The motor unit according to claim 1, wherein the bearing has an upper portion and a lower portion, the upper portion is engaged with the lower-edge portion of the housing, and the lower portion is exposed out of the lower-edge portion.

6. The motor unit according to claim 5, wherein the upper portion of the bearing is within the housing and has a height equal to that of the lower-edge portion.

7. The motor unit according to claim 1, wherein the bearing has an outer diameter equal to or less than an inner diameter of the lower-edge portion of the housing.

8. A motor-control device, comprising:
a main body having a mounting slot; and
the motor unit according to claim 4 disposed within the mounting slot of the main body, wherein the lower portion of the bearing has an outer wall contacting and fitting an inner wall of the mounting slot.

9. The motor-control device according to claim 8, further comprising an actuator that is disposed within the main body and power-transmittably connected to the motor unit.

10. The motor-control device according to claim 9, which is an anti-lock braking device, and wherein the actuator is an oil scavenge pump.
